(19) United States
(12) Patent Application Publication
(10) Pub. No.: US 2024/0018672 A1
(43) Pub. Date: Jan. 18, 2024

(54) METHOD FOR MANUFACTURING WATER-ELECTROLYSIS CATALYST ELECTRODE INCLUDING COBALT BORIDE NANOPARTICLES SYNTHESIZED WITH THERMAL PLASMA, AND WATER-ELECTROLYSIS CATALYST ELECTRODE ACCORDING TO SAME

(71) Applicant: JEJU NATIONAL UNIVERSITY INDUSTRY-ACADEMIC COOPERATION FOUNDATION, Jeju-si (KR)

(72) Inventors: Sooseok CHOI, Jeju-si (KR); Jeong-Hwan OH, Jeju-si (KR)

(21) Appl. No.: 18/034,918

(22) PCT Filed: Nov. 2, 2021
(86) PCT No.: PCT/KR2021/015717

§ 371 Date: Aug. 14, 2023

(30) Foreign Application Priority Data
Nov. 2, 2020 (KR) 10-2020-0144331

(51) Int. Cl. C25B 11/075; C25B 11/052; C25B 1/04; C25B 11/037

(52) U.S. Cl. CPC C25B 11/075; C25B 11/052; C25B 1/04; C25B 11/037

(57) ABSTRACT

The present invention relates to a method for manufacturing a water-electrolysis catalyst electrode including cobalt boride nanoparticles, the method comprising: preparing cobalt boride nanoparticles with thermal plasma; and manufacturing an electrode including the prepared cobalt boride nanoparticles.

### TECHNICAL FIELD

The present invention relates to a method of producing a water electrolysis catalyst electrode containing cobalt boride nanoparticles synthesized by thermal plasma and a water electrolysis catalyst electrode produced by the method.

### BACKGROUND ART

As energy demand increases, research on conversion to high-efficiency, low-cost, and eco-friendly alternative energy and storage systems is being actively conducted. In particular, the conversion of water into oxygen and hydrogen is a key energy conversion technology and is a part of renewable resource storage in the form of chemical fuels. Recently, electrochemical hydrogen production mainly relies on general water electrolysis and the chloroalkali industry. In fact, water splitting is considered to be an eco-friendly and economical sustainable hydrogen supply method. Therefore, it is highly important to develop more effective and highly stable catalyst electrode materials. Water splitting may be divided into two half-cell reactions. One reaction is the hydrogen evolution reaction (HER) that occurs at the cathode, and the other is the oxygen evolution reaction (HER) that occurs at the anode.

From a practical point of view, the development of an efficient and stable catalyst for the oxygen evolution reaction, which is more complex than the hydrogen evolution reaction in terms of mechanism and requires a lot of overpotential, is very important for commercialization of hydrogen production through large-scale water electrolysis. Noble metal oxide catalysts such as RuO₂ and IrO₂ exhibit high activity, but application of noble metal oxide catalysts at large scale is difficult due to the high cost and scarcity thereof. Therefore, there has been a demand for a technology for developing an efficient catalyst that can replace expensive catalysts from materials abundant in the earth. In particular, an oxygen evolution reaction in an acid atmosphere severely limits the use of non-noble metal-based catalysts. Therefore, non-noble metal-based oxygen evolution catalysts in a basic atmosphere have been proposed.

Meanwhile, in the hydrogen evolution reaction, the development of non-platinum catalysts to replace expensive Pt-based catalysts is actively conducted. However, contrary to the oxygen evolution reaction, disadvantageously, most catalysts operate only in an acidic atmosphere. In view of the use of non-noble metals, this unbalance is regarded as a major obstacle in terms of the ultimate completion of water electrolysis using non-noble metal catalysts. Therefore, there is an urgent need for the development of non-noble metal-based hydrogen generation catalysts in a basic atmosphere.

Transition metals such as nickel, cobalt, and copper may be potent candidates for low-cost and efficient alternatives. Among non-precious metals, cobalt has received a great deal of attention in the oxygen evolution reaction. In particular, cobalt boride is reported to have excellent catalytic activity for water splitting, because boron prevents cobalt metal from being oxidized as a sacrificial element, and the catalytic activity of cobalt can be improved based on electron transfer from cobalt to boron.

Meanwhile, in recent years, catalysts such as nanoparticles, nanowires, nanosheets, and nanotubes have been designed to improve surface area and electrical conductivity based on modification of various shapes or structures.

In general, nanoscale catalysts are synthesized by chemical reduction through a multi-step process, thus disadvantageously causing a problem of requiring a long synthesis time and several solvents.

### DISCLOSURE

### Technical Problem

It is one object of the present invention to provide a method for preparing a water electrolysis catalyst containing cobalt boride nanoparticles that is capable of achieving high efficiency at a low cost and exhibiting excellent long-term stability (durability).

It is another object of the present invention to provide a water electrolysis catalyst electrode containing cobalt boride nanoparticles that is capable of simultaneously generating hydrogen and oxygen at an anode and a cathode, respectively.

### Technical Solution

In accordance with one aspect of the present invention, the above and other objects can be accomplished by the provision of a method of producing a water electrolysis catalyst electrode containing cobalt boride nanoparticles including preparing cobalt boride nanoparticles using thermal plasma and producing an electrode containing the prepared cobalt boride nanoparticles.

The cobalt boride nanoparticles may be prepared by thermal plasma in a triple torch-type plasma device.

The cobalt boride nanoparticles may have a size of 1 to 20 nm.

The producing the electrode may include preparing a catalyst ink containing the cobalt boride nanoparticles, and coating the electrode with the catalyst ink.

The preparing the catalyst ink may include mixing cobalt boride nanoparticles, propanol, deionized water, and an additive and then ultrasonicating the resulting mixture for 50 to 70 minutes, and the coating the electrode with the catalyst ink may include applying the ultrasonicated catalyst ink to the electrode, followed by drying.

The additive may be a tetrafluoroethylene-perfluoro-3,6-dioxa-4-methyl-7-octenesulfonic acid copolymer.

The amount of the cobalt boride nanoparticles contained in the electrode may be 1 to 1.5 mg per a surface area (cm²) of the electrode.

The preparing the cobalt boride nanoparticles may include injecting a plasma-forming gas into a triple torch-type plasma jet device to generate a plasma jet, injecting a cobalt/boron mixture into the plasma jet using a carrier gas, followed by vaporization, and cooling the vaporized cobalt/boron mixture to recover the cobalt boride nanoparticles.

The cobalt and the boron in the cobalt/boron mixture may be mixed in a molar ratio of 1:0.5 to 1:4.

In accordance with another aspect of the present invention, provided is a water electrolysis catalyst electrode produced using the method described above.

The water electrolysis catalyst may generate hydrogen and oxygen at an anode and a cathode, respectively.

### Advantageous Effects

The present invention provides a water electrolysis catalyst electrode having excellent overpotential, current density, surface area and long-term stability, and the prepared water electrolysis catalyst electrode has excellent oxygen evolution reaction (OER) and hydrogen evolution reaction (HER) at a cathode and an anode, respectively.

In addition, the method of preparing cobalt boride nanoparticles is implemented by a single step, thus providing advantages of obtaining a high yield, short preparation time and reduced preparation costs.

### DESCRIPTION OF DRAWINGS

FIG. 1 illustrates a process of synthesizing nanoparticles using thermal plasma (using a triple torch-type plasma device).

FIG. 2 shows a triple torch-type plasma jet device according to an embodiment of the present invention.

FIGS. 3(a) to 3(f) show FE-TEM images and SAED patterns of cobalt boride nanoparticles according to an embodiment of the present invention, and FIG. 3(g) is a graph showing the size of cobalt boride nanoparticles according to Table 1.

FIG. 4 is an XPS graph showing the analyzed chemical surface morphology of the cobalt boride nanoparticles of Example 1.

FIG. 5 shows a linear sweep voltammetry (LSV) graph, an overpotential, and a Tafel slope for the oxygen evolution reaction of the catalyst electrodes of Examples 1 to 3.

FIG. 6 shows a cyclic voltammetry (CV) graph as a function of scan rate and a long-term stability test graph.

FIG. 7 shows a linear sweep voltammetry (LSV) graph, overpotential, Tafel slope, and long-term stability test graph of the hydrogen evolution reaction of catalyst electrodes of Examples 1 to 3 of the present invention.

### BEST MODE

The present invention provides a method of producing a water electrolysis catalyst electrode containing cobalt boride nanoparticles including preparing cobalt boride nanoparticles using a thermal plasma and producing an electrode containing the prepared cobalt boride nanoparticles.

### MODE FOR INVENTION

Hereinafter, a preferred embodiment of the present invention will be described in detail with reference to the accompanying drawings. First of all, it should be noted that in the drawings, the same components or parts are designated by the same reference numerals as much as possible. In describing the present invention, detailed descriptions of related well-known functions or configurations are omitted in order not to obscure the subject matter of the present invention.

As used herein, the terms “about”, “substantially”, and the like are used to refer to a certain value or a value close thereto when unique manufacturing and material tolerances are presented and the terms are used to prevent unscrupulous infringers from unfair use of the disclosure including accurate or absolute figures provided for better understanding of the present invention.

While researching a method for preparing cobalt boride nanoparticles using a triple torch-type plasma jet device, the present inventor found that the synthesized cobalt boride nanoparticles are highly effective as a water electrolysis catalyst and completed the present invention.

Prior to the description of the present invention, the triple torch-type plasma device used in the present invention will be described.

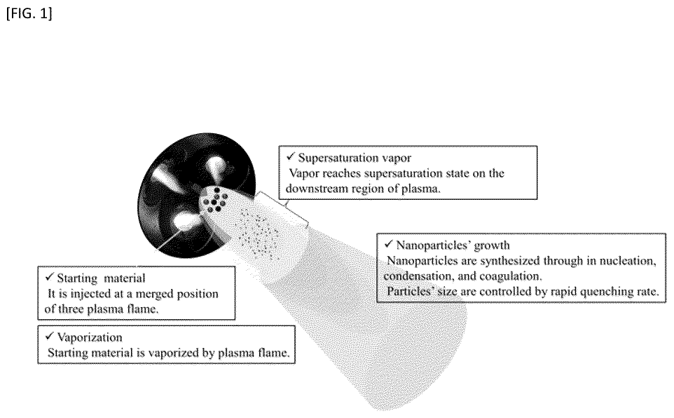

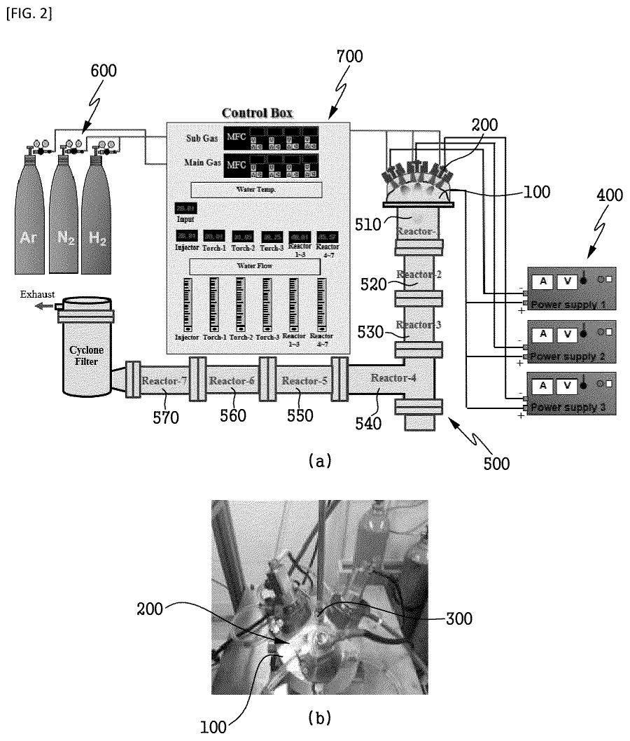

FIG. 1 illustrates a process of synthesizing nanoparticles using thermal plasma (using a triple torch-type plasma device) and FIG. 2 shows a triple torch-type plasma jet device according to an embodiment of the present invention.

Generation of the triple torch-type plasma jet used in the present invention is preferably performed in a non-transfer manner. In the present invention, the triple torch-type plasma jet device produces cobalt boride nanoparticles in a non-transfer manner in which a DC arc discharge is created between a cathode formed of a tungsten rod and an anode on the inner surface of a nozzle formed of copper, the plasma-forming gas is flowed from the rear as a swirling stream to heat the plasma jet-forming gas by the arc and intense plasma jet streams are ejected from the cathode nozzle.

The plasma jet is an ionized gas composed of electrons, ions, atoms, and molecules generated from the torch using direct current arc or high-frequency inductively coupled discharge and is a high-speed jet with high activity and ultra-high temperature ranging from thousands to tens of thousands of K.

Referring to FIG. 2, the triple torch-type plasma jet device includes a reaction tube 100 configured to provide an area where a plasma jet is formed and raw materials react with each other, a plurality of torches 200 provided at one side of the reaction tube and configured to supply a heat source to a supplied starting material, a raw material feeder 300 provided at one side of each torch and configured to supply the starting material to the torch through a powder supply line, a power supply 400 configured to supply power electrically connected to the torch, a plurality of reactors 500 provided at the bottom of the reaction tube, configured to provide an area where which materials produced by the plasma jet are accumulated and including a quenching system at one side thereof, a forming-gas supply 600 provided at one side of the torch and configured to supply a plasma-forming gas to the torch through a plasma jet-forming gas supply line, and a forming gas-flow rate controller 700 provided in the plasma-forming gas supply line and configured to adjust the flow rate of the plasma-forming gas, wherein the plurality of torches is disposed in a direction in which the starting material is supplied at a predetermined interval such that plasma jets generated from the torches are merged (see FIG. 2).

The number of reactors may be 7, and when the number of reactors is 7, reactors 1 to 4 may be arranged in a vertical direction and reactors 5 to 7 may be arranged in a horizontal direction.

The torches 200 may include three torches and may be disposed on the upper surface of the reaction tube 100 at a predetermined interval.

The torch 200 may further include a cooling system to protect the same from heat.

The raw material supply 300 configured to supply a starting material through a powder supply line is provided at the center of the torches 200 arranged at a predetermined interval.

Hereinafter, a method of producing a water electrolysis catalyst electrode containing cobalt boride nanoparticles synthesized by thermal plasma according to an embodiment of the present invention will be described in detail in a stepwise manner.

The cobalt boride nanoparticles prepared in the present invention prevent oxidation of cobalt using boron and improve the catalytic activity of cobalt by electron transfer from cobalt to boron.

The method of producing the water electrolysis catalyst electrode according to an embodiment of the present invention includes preparing cobalt boride nanoparticles using thermal plasma and producing an electrode including the prepared cobalt boride nanoparticles.

First, cobalt boride nanoparticles are prepared using the thermal plasma.

The preparation of the cobalt boride nanoparticles may be performed by thermal plasma of a triple torch-type plasma device.

Specifically, the preparation of the cobalt boride nanoparticles includes injecting a plasma-forming gas into a triple torch-type plasma jet device to generate a plasma jet, injecting a cobalt/boron mixture into the plasma jet using a carrier gas and inducing vaporization, and cooling the vaporized cobalt/boron mixture to recover cobalt boride nanoparticles.

The generation of the plasma jet is performed by setting a current of 100 A to the triple torch-type plasma jet device and injecting the plasma-forming gas at a flow rate of 16 to 28 L/min.

The plasma-forming gas is a mixture of argon and hydrogen.

The cobalt boride nanoparticles may be produced using the mixture gas as a plasma-forming gas.

In the present invention, the size of the cobalt boride nanoparticles can be set by changing the flow rate of the plasma jet-forming gas, the cooling rate of the cobalt/boron mixture melted and vaporized by the plasma jet, the potential or current of the plasma and the like.

Then, the cobalt/boron mixture was injected into the plasma jet, followed by vaporization.

The cobalt/boron mixture may be a mixture of cobalt and boron in a molar ratio of 1:0.5 to 1:4.

The cobalt/boron mixture may be prepared in three torches and supplied in a merged plasma jet direction, and specifically, at a rate of 0.5 to 0.6 g/min. In addition, the supply of the cobalt/boron mixture may be performed using a carrier gas, and the carrier gas may be argon and may be injected at a flow rate of 4 to 6 L/min.

In the final step for preparing the cobalt boride particles, the vaporized cobalt/boron mixture is cooled to recover the cobalt boride nanoparticles.

A cooling system may be further provided in the reactors (1 to 7) to cool the vaporized cobalt/boron mixture, but is not limited thereto.

The cooling is natural cooling and cobalt boride nanoparticles are produced as the vaporized cobalt/boron mixture is cooled.

The cobalt boride nanoparticles may be recovered from each reactor (each of reactors 1 to 7) and a separate recovery system may be further provided, but is not limited thereto.

The size of the cobalt boride nanoparticles prepared using the method may be 1 to 20 nm, preferably 1 to 12 nm.

When the size of the cobalt boride nanoparticles is less than 1, advantageously, the active cross-sectional area of the catalyst is improved, but there is a problem in that the yield is lowered during production, and when the size exceeds 20 nm, the active cross-sectional area of the catalyst is reduced, resulting in deterioration in effects of oxygen evolution reaction or hydrogen evolution reaction.

As described above, the cobalt boride nanoparticles are produced in a single step, thus having advantages of short preparation time and high energy efficiency.

Finally, an electrode including the prepared cobalt boride nanoparticles is produced.

The production of the electrode includes preparing a catalyst ink including the cobalt boride nanoparticles, and coating the electrode with the catalyst ink.

The preparation of the catalyst ink including the cobalt boride nanoparticles is performed by mixing the cobalt boride nanoparticles, propanol, deionized water, and an additive, and then ultrasonicating the resulting mixture for 50 to 70 minutes.

When the ultrasonication time does not fall within the range defined above, there is a problem that the catalyst ink is not completely prepared. The ultrasonication time is preferably within the range defined above.

The additive is a tetrafluoroethylene-perfluoro-3,6-dioxa-4-methyl-7-octenesulfonic acid copolymer.

In addition, the coating the electrode with the catalyst ink is performed by applying the catalyst ink applied to the electrode, followed by drying.

The coating may be performed by applying 4 μL of the catalyst ink to the electrode using a pipette and the drying may be performed at room temperature for 40 to 50 minutes.

The electrode may be a glassy carbon electrode and the amount of cobalt boride nanoparticles contained in the electrode may be 1 to 1.5 mg per the area (cm²) of the electrode surface, preferably 1.2 mg per the area (cm²) of the electrode surface.

When the amount of cobalt boride nanoparticles contained in the surface of the electrode does not fall within the range, disadvantageously, cracks may occur after the applied ink is dried, and the electrode coating is not complete. Therefore, the amount of cobalt boride nanoparticles preferably falls within the range defined above.

The present invention provides a water electrolysis catalyst electrode containing cobalt boride nanoparticles prepared using the method.

The water electrolysis catalyst electrode according to an embodiment of the present invention can generate hydrogen and oxygen at the anode or the cathode, respectively, and specifically, cause excellent hydrogen evolution reaction or oxygen evolution reaction at the anode or cathode in an alkaline electrolyte (1M KOH).

More specifically, in the oxygen evolution reaction, an overpotential of 335 mV compared to the reversible hydrogen electrode (RHE) can be obtained at a current density of 10 mA/cm² and a Tafel slope of 49 mV/dec. In the hydrogen evolution reaction, a relatively high Tafel slope of 92 mV/dec and a low active surface area of 1.2 mF/cm² can be obtained.

In addition, the water electrolysis catalyst electrode of the present invention maintains long-term stability of ±10 Ma/cm² for 10 hours for oxygen evolution reaction and hydrogen evolution reaction.

Hereinafter, the present invention will be described in more detail with reference to the following Examples and Experimental Examples.

### Preparation Examples 1 to 3: Preparation of Cobalt Boride Nanoparticles

Plasma-forming gas was supplied to the torch of the triple torch-type plasma jet device shown in FIG. 2 and a plasma jet was generated under the operating conditions shown in Table 1 below.

Then, a cobalt/boron mixture (1:3 mol %) was supplied to a triple torch-type plasma jet device and vaporized.

Finally, the vaporized cobalt/boron mixture was cooled and the solidified cobalt boride nanoparticles were recovered.

Here, commercially available cobalt (1 μm, purity 95%) and amorphous boron (2 μm, purity 99.8%) were used and the operating time was 20 minutes.

TABLE 1

| | | Prepara- | Prepara- | Prepara- |
|---|---|---|---|---|
| | | tion | tion | tion |
| | | Example 1 | Example 2 | Example 3 |
| Item | | (EXP 1) | (EXP 2) | (EXP 3) |
| Starting | Molar ratio of Co/B | 1:3 | | |
| material | (cobalt/boron) | | | |
| Condition | Flow rate of plasma- | 14 Ar | 11 Ar | 8 Ar |
| of plasma | forming gas (L/min) | 14 H₂ | 11 H₂ | 8 H₂ |
| generation | Flow rate of carrier | 5 Ar | 5 Ar | 5 Ar |
| | gas (L/min) | | | |
| | Plasma input power | 27 | 24 | 21 |
| | (kW) | | | |
| | Feeding rate of starting | 0.5 | | |
| | material (g/min) | | | |

| | |
|---|---|
| Operating pressure | 101.325 |
| (kPa) | |

| | | | |
|---|---|---|---|
| Yield (%) | 73 | 50 | 58.5 |

As can be seen from Table 1 above, 5.85 g (yield, 58.2%) of cobalt boride particles were obtained for operating time of 20 minutes.

### Example 1

20 mg of cobalt boride nanoparticles prepared in Preparation Example 1, 300 μL of propanol, 700 μL of deionized water and 10 μL of a tetrafluoroethylene-perfluoro-3,6-dioxa-4-methyl-7-octenesulfonic acid copolymer (5 wt %, Tafion, Sigma-Aldrich) were mixed and ultrasonicated for 60 minutes to prepare a catalyst ink.

The previously washed glass carbon electrode was coated with the prepared catalyst ink at 1.2 mg/cm² using a pipette and then dried in air for 50 minutes to produce a catalyst electrode.

### Example 2 and Example 3

Catalyst electrodes were produced in the same manner as in Example 1, except that the cobalt boride nanoparticles prepared in Preparation Examples 2 and 3 were used.

Experiment Method

The morphology and structure of cobalt boride nanoparticles were observed by field emission transmission electron microscopy (FE-TEM, JEM-2100, JEOL, Japan) at an accelerating potential of 200 kV in SAED patterns, and the surface morphology and atomic composition were investigated by X-ray photoelectron spectroscopy (XPS, K-Alpha, Thermo Scientific Ins, USA).

All electrochemical properties were measured with three electrodes using Autolab (PGSTAT128N potentiostat/galvanostat, Metrohm, Switzerland).

A glass carbon electrode with a diameter of 3 mm was used as a working electrode, a platinum sheet was used as a counter electrode, and Ag/AgCl/3M KCl with a double junction was used as a reference electrode.

In the present invention, all potentials were calculated based on a reversible hydrogen electrode (RHE) using Equation 1 below.

E_{RME}=E_{Ag/AgCl}+0.1976V+(0.059×pH)) [Equation 1]

In the present invention, 1M KOH (pH 14) was used as each electrochemical electrolyte and all solutions were measured while continuously stirring to prevent bubbles from accumulating on the working electrode.

Oxygen evolution reaction (OER) was measured by linear sweep voltammetry (LSV) from 0.5 to 2V (vs. RHE) at a scan rate of 10 mV/s and at an electrode rotation rate of 1,600 rpm.

The double-layer capacitance (C_{dl}) was analyzed by cyclic voltammetry (CV) at a non-induced current potential ratio of 1.1 to 1.4 V (vs. RHE) at a scan rate of 20 to 120 mV/s.

For hydrogen evolution reaction (HER) measurements, the LSV between 0 and −1 vs RHE was determined at a scan rate of 10 mV/s using electrode rotating at 1,600 rpm and then a double-layer capacitance (C_{dl}) was measured at the same scan rate as in the oxygen evolution reaction (OER) and at 0.4 to 0.6V vs RHE.

Long-term stability was analyzed using a time electrometer at a current density of 10 mA/cm² in 1 M KOH with electrode rotating at 1,600 rpm.

### Results and Analysis

### Experimental Example 1: FE-TEM Image and SAED Pattern Analysis

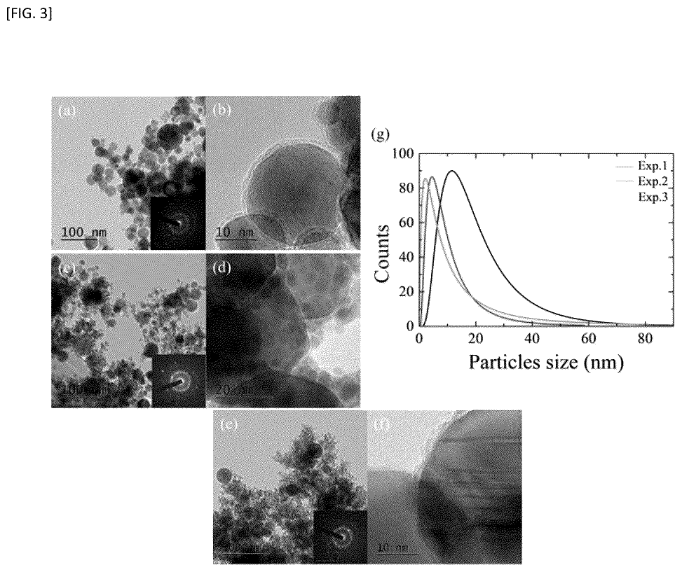

FIGS. 3(a) to 3(f) show FE-TEM images and SAED patterns of cobalt boride nanoparticles according to an embodiment of the present invention, and FIG. 3(g) is a graph showing the size of cobalt boride nanoparticles according to Table 1.

As can be seen from FIGS. 3(a) to 3(f), spherical cobalt boride nanoparticles in the FE-TEM images were not as large as initially fed cobalt and boron particles.

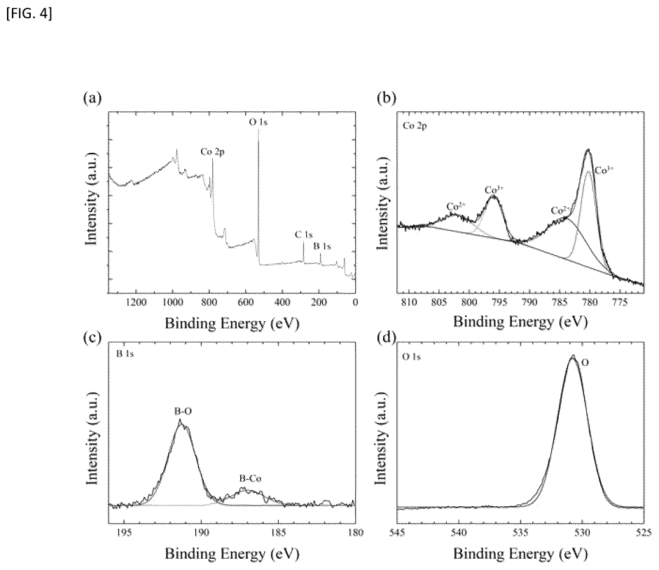

In addition, initial (non-evaporated) cobalt and boron peaks were not observed in the XRD graphs of FIGS. 4(a) to 4(d) and CoB crystals were more predominant than CO₂B crystals.

That is, it can be seen that both the fed cobalt and boron were completely vaporized by the thermal plasma.

In addition, from the HR-TEM images of FIGS. 3(a) to 3(f), it can be seen that CoB and Co₂ crystal structures are planar.

As can be seen from FIG. 3(g), the size (5 to 15 nm) of synthesized cobalt boride nanoparticles decreases when the flow rate of the gas injected into the triple torch-type plasma device decreases.

The results showed that the size of synthesized nanoparticles can be adjusted by changing the flow rate of gas and cobalt boride nanoparticles having excellent crystallinity can be synthesized by one step without a post-treatment process.

### Experimental Example 2: Analysis of Chemical Surface Morphology of Cobalt Boride Nanoparticles

FIG. 4 is an XPS graph showing the analyzed chemical surface morphology of the cobalt boride nanoparticles of Example 1.

The 785.40 eV and 802.30 eV peaks shown in the cobalt 2p XPS graph of FIG. 4(b) are derived from the vibration of Co⁺² high-spin, and the 780.6 eV and 796.3 eV peaks are derived from the vibration of the core level spectrum of Co⁺³.

In particular, the binding energy of Co⁺³ in the cobalt boride nanoparticles was positively shifted by CoO or Co(OH)₂ accidentally formed by exposure to the air during the synthesis process.

The positive shift of the binding energy further upregulates the catalytic performance of oxygen evolution reaction of the cobalt boride nanoparticles.

As can be seen from boron is XPS graph of FIG. 4(c), two binding energy peaks of 187 and 191.5 eV were observed.

The 187 eV peak is formed by the interaction of boron and cobalt, and the 191.5 eV peak is formed by boron-oxide.

As can be seen from the HR-TEM image of FIG. 3, the boron oxide (thin hydroxide or oxide film) surrounds the surface of the cobalt boride nanoparticles and this is similar to a core-shell structure.

### Experimental Example 3: Oxygen Evolution Reactivity Analysis

Oxygen evolution reactions of Examples 1 to 3 were tested in a 1M KOH solution using a three-electrode electrochemical cell and a rotating disk electrode.

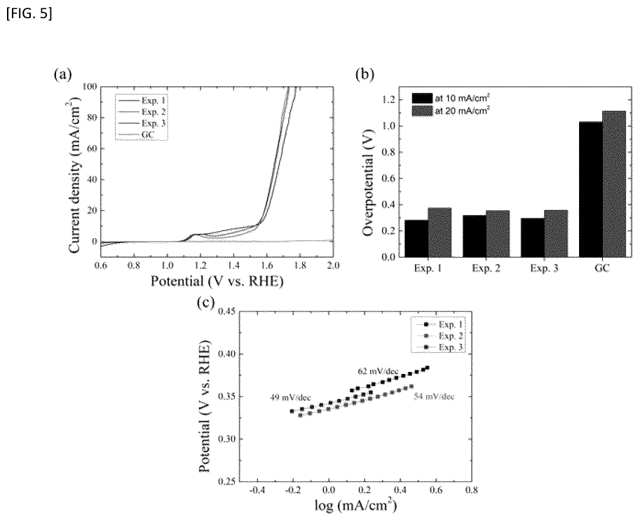

FIG. 5 shows a linear sweep voltammetry (LSV) graph, an overpotential, and a Tafel slope for the oxygen evolution reaction of the catalyst electrodes of Examples 1 to 3.

As can be seen from FIG. 5(a), the LSV graphs for all oxygen evolution reactions of Examples 1 to 3 exhibit polarization curves and oxygen evolution reactions of Examples 1 to 3 were better than that of the glass carbon electrode (GC) without a catalyst.

In addition, Example 1, in which the size of the cobalt boride nanoparticles was large, exhibited lower current densities than those of Examples 2 and 3, and current densities of Examples 2 and 3 were similar.

FIG. 5(b) exhibited the activity of Examples 1 to 3 and the glass carbon electrode having no catalyst at overpotentials of 10 mA/cm² and 20 mA/cm².

As can be seen from FIG. 5(b), Example 2 and Example 3 exhibited similar overpotentials of 355 mV (0.355V) and 357 mV (0.357V) at 20 mA/cm², whereas Example 1 exhibited a relatively high 374 mV (0.374V), and the Tafel slopes of Examples 1 to 3 were consistent with the Tafel equation.

The calculated Tafel slope of Example 3 was 49 mV/dec, the calculated Tafel slope of Example 1 was 62 mV/dec and the calculated Tafel slope of Example 2 was 54 mV/dec, which was lower than that of Example 1.

The results showed that the electrode of Example 3 having a smaller particle size than that of Examples 1 and 2 exhibits better oxygen generation reaction.

### Experimental Example 4: Analysis of Electrochemically Active Surface Area (ECSA) and Stability

Electrochemically active surface area (ECSA) of Examples 1 to 3 was analyzed in a non-faraday reaction region using cyclic voltammetry (CV) at different scan rates of 20 to 120 mV/s.

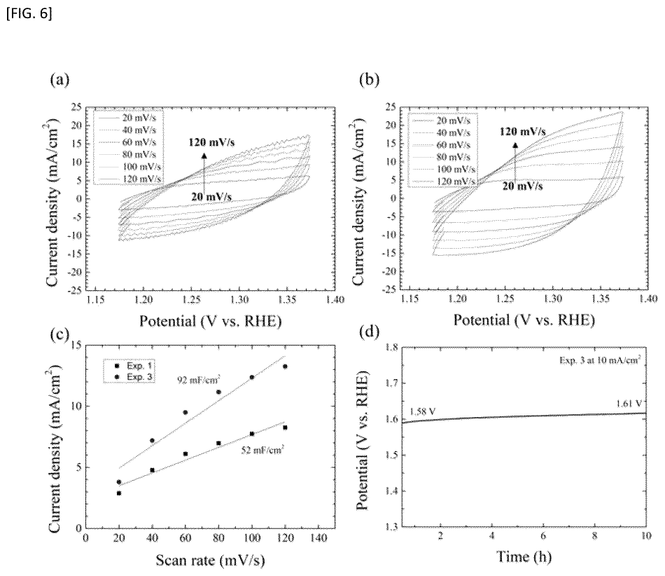

FIG. 6 shows a cyclic voltammetry (CV) graph as a function of scan rate and a long-term stability test graph.

The double-layer capacitance (C_{dl}) proportional to the electrochemically active surface area can be calculated from the slope of the cyclic voltammetry (CV) graph as a function of scan rate in FIGS. 6(a) and 6(b).

As can be seen from FIG. 6(c), Example 1 has a double-layer capacitance of 52 mF/cm², and Example 3 has a double-layer capacitance (C_{dl}) of 92 mF/cm² which is greater than that of Example 1.

The results showed that Example 3 has a better active surface area and thus excellent oxygen evolution reaction activity, compared to Examples 1 and 2.

The long-term stability of Example 3 was analyzed using a galvanostatic polarization of 10 mA/cm² in 1M KOH electrolyte.

As can be seen from FIG. 6(d), the electrode of Example 3 exhibited stable performance, although the potential slightly increased from 1.58V to 1.61V for 10 hours.

The results showed that the cobalt boride nanoparticles synthesized by thermal plasma can be used as a very excellent and stable catalyst based on a galvanostatic test.

### Experimental Example 5: Hydrogen Evolution Reactivity Analysis

The hydrogen evolution reaction of Examples 1 to 3 was tested in a 1M KOH solution.

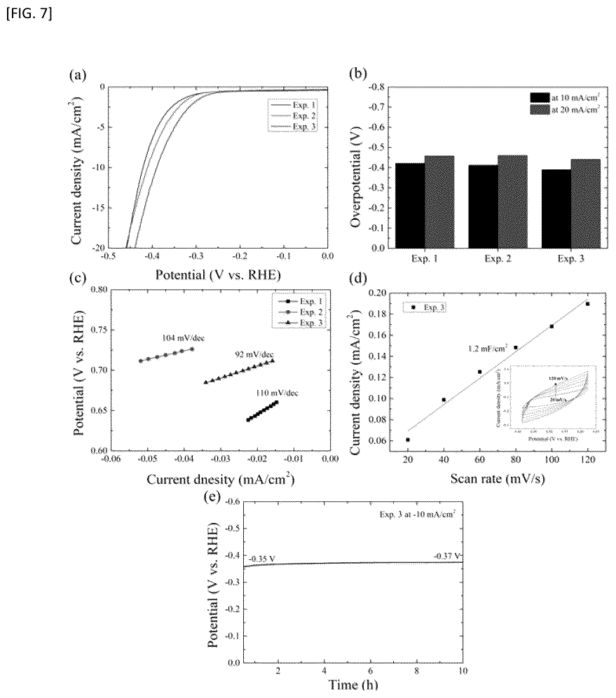

FIG. 7 shows a linear sweep voltammetry (LSV) graph, overpotential, Tafel slope, and long-term stability test graph of the hydrogen evolution reaction of catalyst electrodes of Examples 1 to 3 of the present invention.

As can be seen from FIG. 7, the electrodes of Examples 1 to 3 exhibited an active hydrogen evolution reaction in 1M KOH electrolyte.

As can be seen from FIG. 7(b), among the examples, Example 3 having the smallest particle exhibited an overpotential as low as 389 mV (0.389V) at a current density of 10 mA/cm², while Example 1 and Example 2 exhibited overpotentials of 421 mV (0.421V) and 412 mV (0.412V).

In addition, Example 3 exhibited a low Tafel slope of 92 mV/dec, while Examples 1 and 2 exhibited a higher Tafel slope of 110 mV/dec and 104 mV/dec.

As can be seen from FIG. 7(c), Example 3, in which, as the overpotential decreases, the Tafel slope also decreases, and the particle size is small, exhibits a low overpotential and a low Tafel slope, as in the results of the oxygen evolution reaction experiment, which means an excellent hydrogen evolution reaction.

That is, it can be seen that Example 3 has better hydrogen evolution reaction than Examples 1 and 2, which means that, as the size of the cobalt boride nanoparticles decreases, the hydrogen evolution reaction activity is improved.

The electrochemically active surface area (ECSA) of Example 3 was analyzed by cyclic voltammetry (CV) at a scan rate of 20 to 120 mV/s.

The capacitance (C_{dl}) of hydrogen evolution reaction was 1.2 mF/cm², which was lower than the oxygen evolution reaction (OER) capacitance (C_{dl}) of FIG. 6(c) and the results showed that the cobalt boride nanoparticles can be useful as a better catalyst for the hydrogen evolution reaction than for the oxygen generation reaction.

In addition, in the present invention, the long-term stability of the hydrogen evolution reaction of Example 3 was tested at 1,600 rpm and −10 mA/cm².

As can be seen from FIG. 7(e), Example 3 exhibited stable performance, although the potential slightly increased from 1.58V to 1.61V for 10 hours.

### Experimental Example 6: Comparison of Activity with Various Catalysts in Similar Electrolytes

The following Table 2 shows the result of comparison in OER and HER activities between catalysts prepared by chemical reduction and electroless plating in the same electrolyte at the same pH and the cobalt boride nanoparticles of the present invention.

TABLE 2

| | Synthesis | | Tafel slope |
|---|---|---|---|
| Material | method | Electrolyte | (mV/dec.) |
| Cobalt boride | Thermal plasma | 1M KOH | OER: 49 |
| NP | | | HER: 92 |
| Co₂B-500 | | 0.1M KOH | OER: 45 |
| | Chemical | 1M KOH | HER: 136.2 |
| | reduction | | |
| Co—Ni NP/NS | Chemical | 1M KOH | OER: 77 |
| | reduction | | HER: 127 |
| 3D NNCNTAs | Chemical | 1M KOH | OER: 65 |
| | reduction | | |
| Amorphous | Chemical | 1M KOH | OER: 84 |
| transition | reduction | | |
| metal boride | | | |
| CoB/NF | Electroless | 1M KOH | OER: 80 |
| | plating | | HER: 96 |
| β-Mo₂C NP | Chemical | 1M KOH | HER: 60 |
| | reduction | | |
| β-Mo₂C NR | Chemical | 1M KOH | HER: 66.2 |
| | reduction | | |
| β-Mo₂C NB | Chemical | 1M KOH | HER: 49.7 |
| | reduction | | |
| CoFe₂O₄—Li NP | Chemical | 1M KOH | OER: 42.1 |
| | reduction | | |

* NP: nanoparticles, NS: nanosheets, NR: nanorods, NB: nanobelts 3D NNCNTAs: three-dimensional Ni@[Ni^{(2+/3+)}Co₂(OH)₆₋₇]ₓ nanotube arrays, NF: Nickel foam

Most conventional catalysts are synthesized in a multi-step and chemical reduction requiring a long process time, whereas the catalyst according to the present invention is advantageously capable of preparing cobalt boride nanoparticles with excellent crystallinity even at tens of nanometers or less and the process using the thermal plasma according to the present invention has an advantage of avoiding unnecessary processes such as filtration and drying. In particular, the cobalt boride nanoparticles of the present invention exhibit better OER and HER activities compared to cobalt-based catalysts such as Co₂B-500, Co—Ni NP/NS, and CoB/NF.

Therefore, the method for producing a water electrolysis catalyst electrode containing cobalt boride nanoparticles synthesized by thermal plasma according to the present invention and the water electrolysis catalyst electrode produced using the method exhibit excellent oxygen generation reaction (OER) and hydrogen generation reaction (HER) at the anode or cathode due to excellent overpotential, current density, surface area and long-term stability, and the cobalt boride nanoparticles are prepared in a single step, thus providing economic efficiency of reducing the overall preparation time and costs and improving productivity based on the high yield.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of producing a water electrolysis catalyst electrode containing cobalt boride nanoparticles comprising:
preparing cobalt boride nanoparticles using thermal plasma; and
producing an electrode containing the prepared cobalt boride nanoparticles.

2. The method according to claim 1, wherein the cobalt boride nanoparticles are prepared by thermal plasma in a triple torch-type plasma device.

3. The method according to claim 1, wherein the cobalt boride nanoparticles have a size of 1 to 20 nm.

4. The method according to claim 1, wherein the producing the electrode comprises:
preparing a catalyst ink containing the cobalt boride nanoparticles; and
coating the electrode with the catalyst ink.

5. The method according to claim 4, wherein the preparing the catalyst ink comprises mixing cobalt boride nanoparticles, propanol, deionized water, and an additive and then ultrasonicating the resulting mixture for 50 to 70 minutes, and the coating the electrode with the catalyst ink comprises applying the ultrasonicated catalyst ink to the electrode, followed by drying.

6. The method according to claim 5, wherein the additive is a tetrafluoroethylene-perfluoro-3,6-dioxa-4-methyl-7-octenesulfonic acid copolymer.

7. The method according to claim 1, wherein an amount of the cobalt boride nanoparticles contained in the electrode is 1 to 1.5 mg per a surface area (cm²) of the electrode.

8. The method according to claim 1, wherein the preparing the cobalt boride nanoparticles comprises:
injecting a plasma-forming gas into a triple torch-type plasma jet device to generate a plasma jet;
injecting a cobalt/boron mixture into the plasma jet using a carrier gas, followed by vaporization; and
cooling the vaporized cobalt/boron mixture to recover the cobalt boride nanoparticles.

9. The method according to claim 8, wherein the cobalt and the boron in the cobalt/boron mixture are mixed in a molar ratio of 1:0.5 to 1:4.

10. A water electrolysis catalyst electrode produced using the method according to claim 1.

11. The water electrolysis catalyst electrode according to claim 10, wherein the water electrolysis catalyst generates hydrogen and oxygen at an anode and a cathode, respectively.
